(19) United States
(12) Patent Application Publication
(10) Pub. No.: US 2026/0222271 A1
(43) Pub. Date: Jul. 30, 2026

(54) Energy Adaptive Profile Management

(71) Applicant: Comcast Cable Communications, LLC, Philadelphia, PA (US)

(72) Inventors: Jonathan Alan Leech, Denver, CO (US); Lawrence Wolcott, JR., Denver, CO (US); Orion Gatrell, Denver, CO (US)

(21) Appl. No.: 19/037,744

(22) Filed: Jan. 27, 2025

(51) Int. Cl. H04L 27/36; H04L 27/34

(52) U.S. Cl. CPC H04L 27/36; H04L 27/3405

(57) ABSTRACT

Systems, apparatuses, and methods are described for adapting transmission symbol power in order to save energy. Based on data utilization of a carrier and carrier characterization, moreover, a mask may be generated that masks higher energy states of a modulation scheme in favor of lower energy states. This mask may be applied over a base modulation scheme to lower energy usage while maintaining data utilization.

### BACKGROUND

Communication transceivers that use quadrature amplitude modulation (QAM) schemes use, regardless of the required data utilization, a uniform and predictable amount of energy. This uniformity in energy usage may be inefficient and may be especially impactful in power-constrained transmitters such as mobile phones and spaced based communication systems. Using excess energy needlessly affects business revenue and customer costs.

### SUMMARY

The following summary presents a simplified summary of certain features. The summary is not an extensive overview and is not intended to identify key or critical elements.

Systems, apparatuses, and methods are described for adapting transmission symbol power in order to save energy. Performance of channels and subcarriers of a communication system may be evaluated. Receive power of the devices in the communication system may be adjusted based on the performance evaluation. Moreover, during transmission of data, the data utilization requirements of channels and subcarriers may be characterized to determine the necessary bits per symbol for data transfer. Based on the performance evaluation of channels/sub-carriers used for sending data, multiple masks may be generated. The generated masks may use lower power requirements of underutilized bandwidth on a carrier wave, yet have sufficient constellation density to provide for the data utilization requirements. These masks may be analyzed to determine energy use, and a mask that satisfies data utilization requirements and reduces the amount of energy used may be selected. By determining underutilized bandwidth capacity on a carrier wave, content may be more tightly packaged on the carrier wave with smaller amplitudes, so that the energy required to generate the wave is reduced.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows hardware elements of a computing device.

FIG. 3A shows an example plot of a measured modulation error ratio (MER) for a plurality of subcarriers in an orthogonal frequency-division multiplexing (OFDM) channel.

FIG. 3B shows an example of a plurality of QAM constellations.

FIGS. 4A and 4B show modified quadrature amplitude modulation (QAM) signal constellation diagrams that include example values for symbol power.

FIG. 4C shows an example of how a mask may be used to reduce power when data throughput requirements can be satisfied using fewer bits per symbol.

FIG. 5 shows an example of applying a mask to a 256-QAM base modulation to result in 64 unmasked symbols.

FIGS. 6A and 6B show examples of applying a mask to a 256-QAM base modulation.

FIG. 7 shows an example of applying a mask to a 256-QAM base modulation.

FIG. 8 is a flow chart showing an example method for determining a mask based on analyzing utilization and energy used by a CMTS service group.

FIG. 9 shows a sequence diagram depicting a simplified flow of upstream and downstream data between a member device and a CMTS.

FIG. 10 shows a sequence diagram for a system comprising an EPMS, a CMTS, and member devices of the CMTS.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

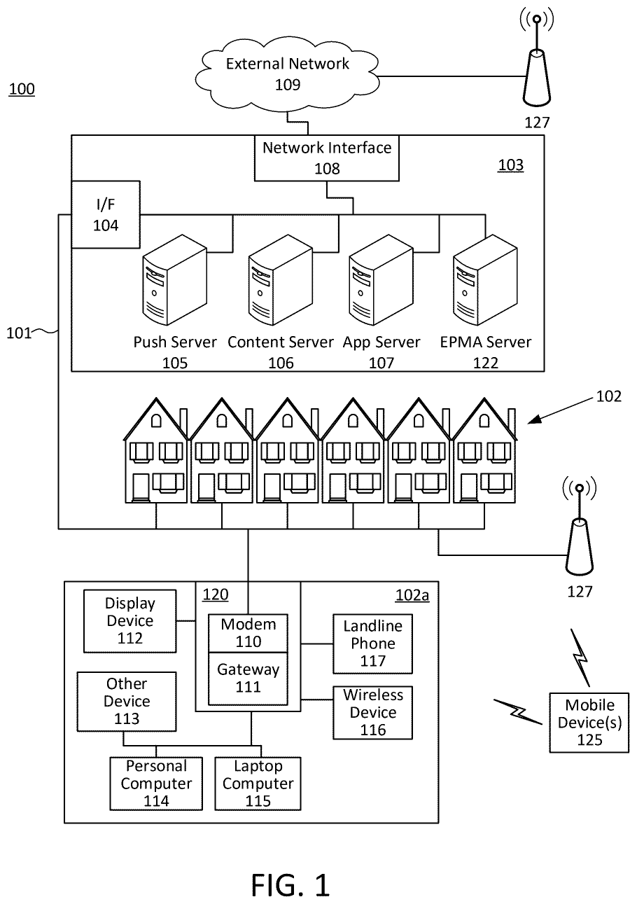

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a WiFi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers communicatively coupled to other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107 and 122 and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (or, alternatively, an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as an energy adaptive profile management (EPMA) server 122 (described below), additional push, content, and/or application servers, and/or other types of servers. Although shown separately, the push server 105, the content server 106, the application server 107, the EPMA server 122, and/or other server(s) may be combined. The servers 105, 106, 107, and/or other servers, may be computing devices and may comprise memory storing data and also storing computer executable instructions that, when executed by one or more processors, cause the server(s) to perform steps described herein. Also or alternatively, one or more of servers 105, 106, 107, and 122, and/or other servers, may be part of the external network 109 and may be configured to communicate (e.g., via the local office 103) with computing devices located in or otherwise associated with one or more premises 102.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise a set-top box (STB), digital video recorder (DVR), a digital transport adapter (DTA), a computer server, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone-DECT phones), mobile phones, mobile televisions, personal digital assistants (PDA)), landline phones 117 (e.g., Voice over Internet Protocol-VoIP phones), and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises.

The mobile devices 125, one or more of the devices in the premises 102a, and/or other devices may receive, store, output, and/or otherwise use assets. An asset may comprise a video, a game, one or more images, software, audio, text, webpage(s), and/or other content.

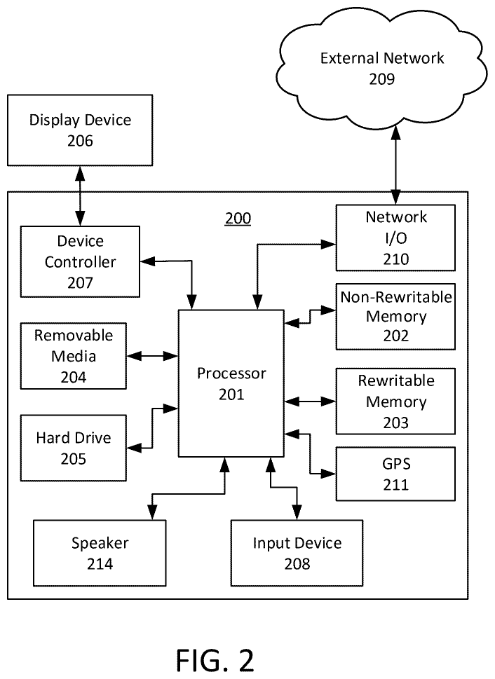

FIG. 2 shows hardware elements of a computing device 200 that may be used to implement any of the computing devices shown in FIG. 1 (e.g., the mobile devices 125, any of the devices shown in the premises 102a, any of the devices shown in the local office 103, any of the wireless access points 127, any devices with the external network 109) and any other computing devices discussed herein (e.g., the EPMA server 122 or other computer executing an energy adaptive profile management application, a cable modem termination system, a cable modem, a mobile phone, a mobile device, etc.). The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output devices, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), microphone, etc. The computing device 200 may also comprise one or more network interfaces, such as a network input/output (I/O) interface 210 (e.g., a network card) to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also or alternatively be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

Modulation error ratio (MER) is a metric that may be used to analyze the performance of one or more channels associated with a service group (e.g., a cable modem termination system (CMTS) service group) that uses a modulation technique (e.g., quadrature amplitude modulation (QAM)). A channel may comprise a portion (e.g., a frequency range) of available communication medium bandwidth, may comprise one or more carriers and/or one or more subcarriers, and may be modulated to create an information-carrying signal. MER, (e.g., receive MER (RxMER), transmit MER (TxMER), etc.), usually expressed in decibels (dB), may be a ratio of average constellation power to average constellation error power.

A constellation, described in more detail below, is a representation of symbols in signals modulated using a modulation scheme (e.g., QAM). MER may be calculated as shown in Equation (1).

$$MER = 10 {log}_{10} [ \frac{{\sum }_{j = 1}^{N} ( {I}_{j}^{2} + {Q}_{j}^{2} )}{{\sum }_{j = 1}^{N} ( δ {I}_{j}^{2} + δ {Q}_{j}^{2} )} ] \qquad Eq . ( 1 )$$

In Equation (1), I and Q are the real (e.g., the in-phase) and imaginary (e.g., the quadrature (90 degrees out of phase)) parts of an ideal target symbol vector. The I and Q parts of the ideal target symbol vector may be mapped to a Cartesian coordinate system having an I and a Q axis, by using the I and Q parts as an ordered pair. In Equation (1), δI and δQ are the real (e.g., the in-phase) and imaginary (e.g., quadrature) parts of each modulation error vector. δI and δQ represent the distance a symbol may be from its ideal target symbol vector (e.g., its constellation point). The ordered pair (1, 1), for example, may represent the ideal target symbol vector having both I and Q equal to 1 and δI and δQ may be 0.1 and 0.2, respectively, for example, if the I and Q of the actual symbol vector are 1.1 and 1.2, respectively. Finally, in Equation 1, the counter j is an index indicating a j-th element of a set of N target symbol vectors.

Ideally, transmitted symbols fall on an ideal target point (e.g., target constellation point), but in reality symbols may fall around target constellation points. MER describes the spread of symbols around constellation target points. For one or more portions of a communication medium bandwidth with a high MER, for example, a symbol point is sharp (e.g., focused). As the symbol points spread out (e.g., diffuse), the average error power of an average symbol power increases and the MER decreases. MER may be calculated, using the real (e.g., the in-phase) and imaginary (e.g., the quadrature) components of a symbol of a constellation. In a QAM receiver, moreover, MER may be calculated after demodulation.

Each individual subcarrier in an orthogonal frequency-division multiplexing (OFDM) channel may have a number of bits assigned to it. The available bandwidth of a channel may be divided into narrowband subcarriers. Each subcarrier may carry a different number of bits. Assigning the number of bits to subcarriers of a channel based on the subcarrier conditions, for example, may be referred to as bit loading. More bits may be assigned to subcarriers, for example, as the conditions of the subcarrier improve, and the subcarriers with the worst conditions may be assigned the lowest bit rate.

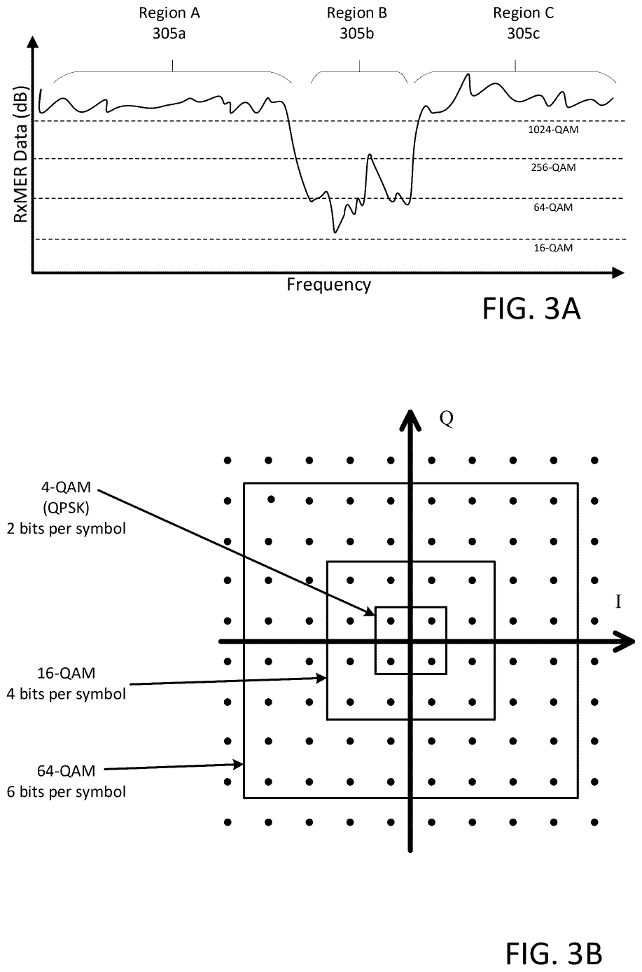

FIG. 3A shows an example plot of a measured MER for a plurality of subcarriers in an OFDM channel. Specifically, FIG. 3A shows an example plot of RxMER per frequency (e.g., for subcarriers of a channel). Regions A 305a and C 305c have a higher MER than region B 305b, indicating a higher ratio of average constellation power to average constellation error power, for example, so one or more portions of a communication medium bandwidth in those regions have a higher capacity to support a higher order QAM constellation that is capable of carrying a greater number of bits per symbol.

FIG. 3B shows an example of a plurality of QAM constellations. Specifically, FIG. 3B shows an example of square grids of three different orders of QAM, a 4-QAM constellation, a 16-QAM constellation, and a 64-QAM constellation. Data is generally transmitted and received as binary, and for a given QAM constellation, each point may be mapped to a sequence of n bits, where 2ⁿ is equal to the quantity of points in the constellation (e.g., each 4-QAM constellation point may be mapped to a 2-bit value and the 4-QAM constellation has 2₂=4 points, each 16-QAM constellation point may be mapped to a 4-bit value and the 16-QAM constellation has 2⁴=16 points, each 64-QAM constellation point may be mapped to a 6-bit value and the 64-QAM constellation has 2⁶=64 points).

QAM is a modulation method used in digital and analog communication systems to send (e.g., transmit) information. The method conveys two signals using an amplitude-shift keying (ASK) and/or an amplitude modulation (AM) scheme. ASK is a method of amplitude modulation where data is represented as variations in the amplitude of one or more portions of a communication medium bandwidth, and AM is a method where the amplitude of the signal is varied in proportion to that of the message signal. Moreover, in QAM, the signals are orthogonal and are out of phase by π/2=90°. The two QAM signals are an I (e.g., an in-phase) signal and a Q (e.g., a quadrature) signal. The two AM signals, the in-phase and the quadrature signals, on a single subcarrier of one or more portions of a communication medium bandwidth, effectively doubles the bandwidth. The orthogonality of the two signals allows them to be demodulated relatively simply. For example, one of the signals may be represented by a sine wave and the other may be represented by a cosine wave. QAM may be used in 802.11 Wi-Fi standards. High spectral efficiencies may be achieved using QAM by choosing an appropriate constellation size. QAM may also be used with pulse AM (PAM) signals in digital systems (e.g., wireless applications).

QAM constellations provide a way to graphically plot the amplitudes and phases of the I and Q signal components of constellation points for a given QAM order. For example, I signal component amplitude may be plotted on the horizontal axis and Q signal component amplitude may be plotted on the vertical axis, with the phases of the I and Q signal components indicated by angles of vectors, extending from the origin through the constellation points, relative to the positive side of the horizontal axis. Each point represents, for a corresponding symbol, the amplitude and phase of both the I and Q components of that symbol. For each symbol period, one symbol may be sent (e.g., transmitted). The number of symbols in the QAM constellation represent the order of the QAM used. In FIG. 3B, the 4-QAM constellation lies within the box labelled 4-QAM. There are 4 constellation points within the constellation and each symbol is 2 bits. In the 4-QAM constellation, for example, the upper left point (−1, 1) may represent 00, the lower left point (−1,−1) may represent 01, the lower right point (1,−1) may represent 10, and the upper right (1, 1) may represent 11. Similarly, in FIG. 3B, the 16-QAM constellation lies within the box labelled 16-QAM, has 16 constellation points, with each constellation point representing a symbol with 4 bits, and with each 16-QAM symbol mapped to a unique bit sequence from 1111 to 0000. The 64-QAM constellation lies within the box labeled 64-QAM, has 64 constellation points, with each constellation point representing a symbol with 6 bits, and with each 64-QAM symbol mapped to a unique bit sequence ranging from 111111 to 000000. Although not shown in FIG. 3B, a 256-QAM constellation may have 256 constellation points, with each constellation point representing a symbol with 8 bits, and with each 256-QAM symbol mapped to a unique bit sequence from 11111111 to 00000000. This pattern may apply for 1024-QAM, for 4096-QAM, etc. QAM symbols may be generated by combining I and Q components. A receiving device may demodulate a QAM signal by recovering the I and Q components to determine points of the appropriate QAM constellation corresponding to those signals.

A profile management application (PMA) may be used to continuously adapt modulation scheme constellation density (e.g., the number of constellation points) and/or to balance utilization (e.g., throughput) and reliability in modulated communication (e.g., data over cable service interface specification (DOCSIS) communications). In a high-fidelity link, for example, the PMA may increase bit rates by using higher-order modulation schemes to deliver reliable utilization (e.g., throughput) at a higher bit rate. Conversely, in a noisy or low-fidelity link, the PMA may use lower-order modulation profiles to deliver fewer bits while maintaining a reliable utilization (e.g., throughput).

MER may be used as a threshold value for determining an order of QAM to use. A MER vs subcarrier plot, moreover, may also include these threshold values for QAM constellations by providing suggested MER limits for one or more QAM constellations. The plot of FIG. 3A, for example, includes threshold values for 16-QAM, 64-QAM, 256-QAM, and 1024-QAM. As the QAM constellation increases in density, the number of bits carried per symbol may also increase. This increase in capacity is one advantage of using higher QAM orders, but may come at a cost of higher sensitivity to noise/error. MER threshold values may be used to determine a level of data transfer utilization (e.g., throughput) to a user. A PMA may receive RxMER data as shown in FIG. 3A, for example, and determine that subcarriers in regions A 305a and C 305c are to use 1024-QAM while subcarriers in region B 305b are to use 16-QAM.

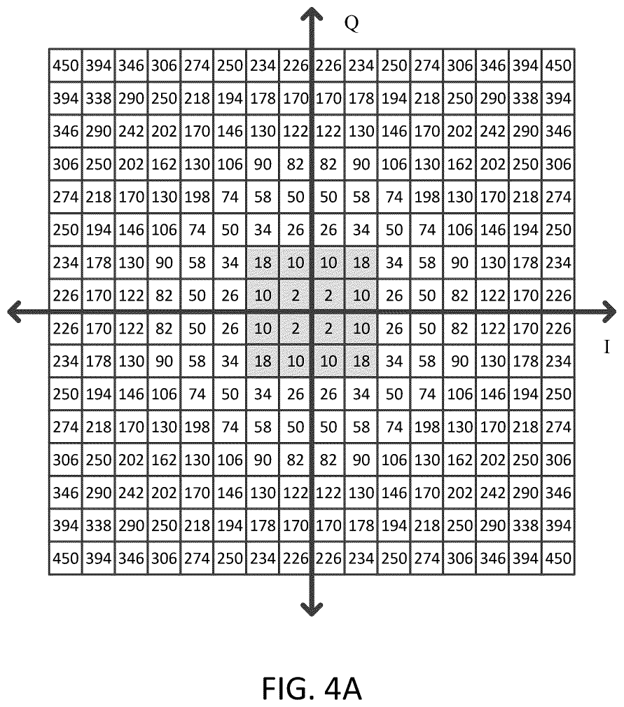

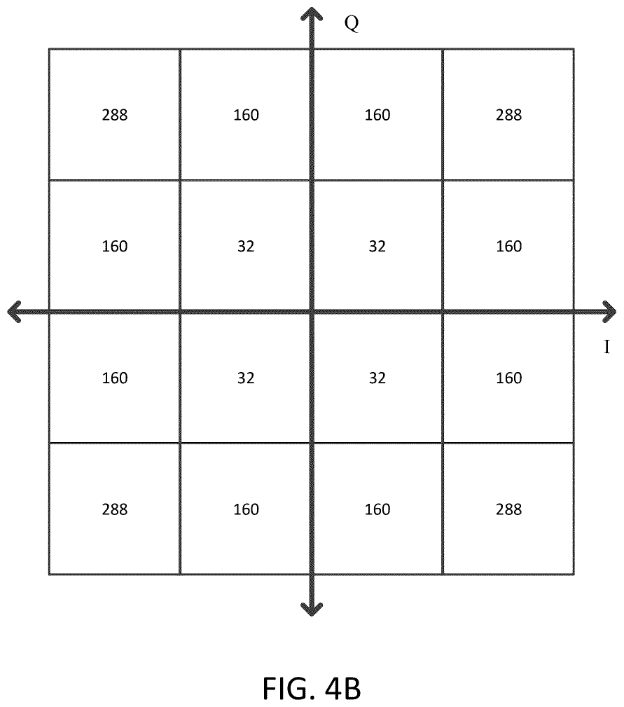

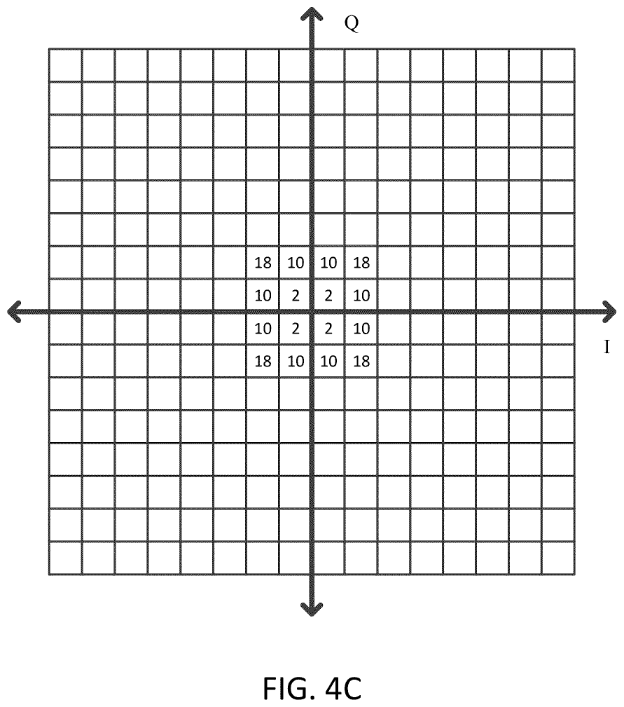

For power constrained transmitters (e.g., mobile phones, space-based communication systems, etc.), a PMA may increase or decrease the modulation order at a fixed power (e.g., as described herein in FIG. 4), so as the bit utilization (e.g., throughput) decreases the energy-per-bit increases and, conversely, as the bit utilization (e.g., throughput) increases the energy-per-bit decreases. The PMA may change the bit rate by changing the QAM order, for example, a PMA may increase the bit rate from 6 bits per symbol period to 8 bits per symbol period by changing from 64-QAM to 256-QAM. Increasing the bit rate may increase the utilization (e.g., throughput) of one or more portions of a communication medium bandwidth while meeting, or exceeding, a reliability target, however, the power used remains constant.

As discussed in more detail below, communications transceivers that use QAM, including OFDM modulation schemes, have a uniform and predictable energy-per-bit rate regardless of the required utilization (e.g., throughput). This is an inefficient use of energy. Instead, maintaining the constellation density while only using the lower power symbols of the constellation, may maintain the utilization (e.g., throughput) and conserve energy at the transmitter. Energy-per-bit and total power (e.g., energy per unit time) may be reduced to conserve energy, for example, if utilization (e.g., throughput) is determined to be low and the higher power symbols at the outer corners of a base modulation constellation are used. Saving power everywhere possible may further energy saving goals of providers and users as well as reduce overhead and costs for stake holders. This issue may be especially impactful in power-constrained transmitters such as mobile phones and space-based communications systems, but may also apply to all QAM and orthogonal frequency-division multiple access (OFDM/A) systems.

OFDM/A profiles are slightly more complicated, as the bit loading can vary throughout the subcarriers. OFDM/A concerns multiple access and may be used if multiple sources are sending data on one or more portions of a communication medium bandwidth. OFDM/A may be used in a DOCSIS upstream and may be organized by the DOCSIS media access control (MAC) protocol which uses a ranging procedure to determine a timing offset for each cable modem (CM) in a CMTS service group. This protocol causes packets sent from member devices at different distances to arrive at the CMTS without overlapping. The methods described herein may be used, similarly, to control the modulation in OFDM/A so that base QAM constellation may use a modulation symbol mask (also referred to herein simply as “mask”) to reduce the total power or energy-per-bit used. For an OFDM/A profile, for example, a set of masks may be applied and subcarriers may be dropped by 2, 4, 8 bits, etc.

Rather than simply adjusting a QAM order, a profile management application may be configured to be dynamic and to adapt transmission energy to accommodate required capacity. Specifically, an EPMA may reduce the symbol power, which reduces the bit rate when not needed, by masking out the high-energy symbols.

FIG. 4A shows a modified QAM signal constellation diagram for 256-QAM. In particular, FIG. 4A shows example power values (e.g., in decibel milliwatts (dBmW) associated with symbols corresponding to the blocks in the modified 256-QAM constellation. Each of the power values shown in FIG. 4A may, for example, be the sum of the instantaneous power values for the I and Q components at a time that those 2 components are combined to create the symbol corresponding to the block of FIG. 4A that contains that power value. Symbols at the corners require the most power to transmit, while symbols near the origin of the constellation require less power to transmit. Prior to modulation, data bits may be pseudo-randomly scrambled and/or otherwise coded so that transmitted symbols are distributed throughout the constellation, and so that overall transmission power remains relatively constant over time. However, if data utilization does not necessitate all available bits of the constellation symbols, this may waste energy. For example, for the 256-QAM constellation of FIG. 4B, each symbol is mapped to a unique sequence of 8 bits. If a symbol rate is R symbols per second, this results in a data transmission rate of 8R bits/second. But if data communication requirements could be satisfied by sending data at a rate of 7R bits/sec, all 8 bits of the 256-QAM symbols may not be used, and the data transmission requirement could be satisfied by transmitting 7 bits per symbol. As mentioned above, QAM communication transceivers may be configured to transmit QAM signals using a power that remains relatively constant, even if QAM order is changed. As shown by the 16 shaded blocks near the origin in FIG. 4A, transmitting those 16 symbols requires substantially less power than is used to transmit symbols at the corners of the 256-QAM constellation. If a QAM transceiver changes from using 256-QAM to 16-QAM, the power used to transmit 256 symbols using 256-QAM may be redistributed over 16 symbols. This is shown in FIG. 4B, a modified QAM signal constellation diagram for 16-QAM that shows example power values (e.g., in decibel milliwatts (dBmW)) associated with symbols corresponding to the blocks in the modified 16-QAM constellation. The density of the 16 symbols in the 16-QAM constellation of FIG. 4B is less than the density of the symbols corresponding to the 16 shaded blocks of FIG. 4A. In particular, symbols of the 16-QAM of FIG. 4B have greater differences in power than the symbols corresponding to the 16 shaded blocks of FIG. 4A, and would thus be easier to detect in noisy channel conditions. And because data bits may be pseudo-randomly scrambled and/or otherwise coded so that transmitted symbols are distributed throughout the constellation, the overall transmission power associated with the 256-QAM of FIG. 4A would be roughly the same as the overall transmission power associated with the 16-QAM of FIG. 4B. The energy-per-bit goes up, because the bit utilization (e.g., throughput) goes down while the power (e.g., the energy-per-time) is held fixed. Although maintaining transmission power levels in this way may be useful to meet or exceed reliability targets (e.g., if channel conditions are degraded), it may be inefficient and waste power (e.g., if a channel is not noisy).

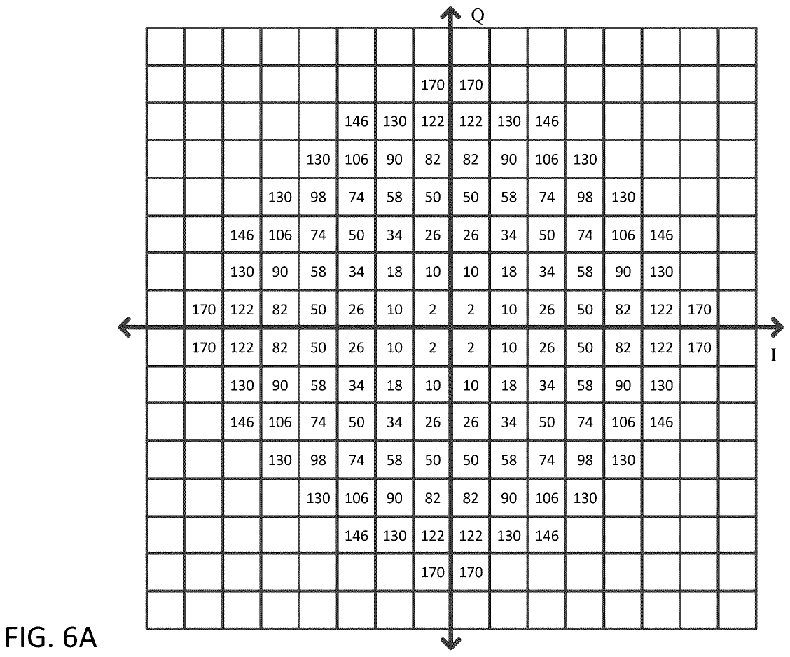

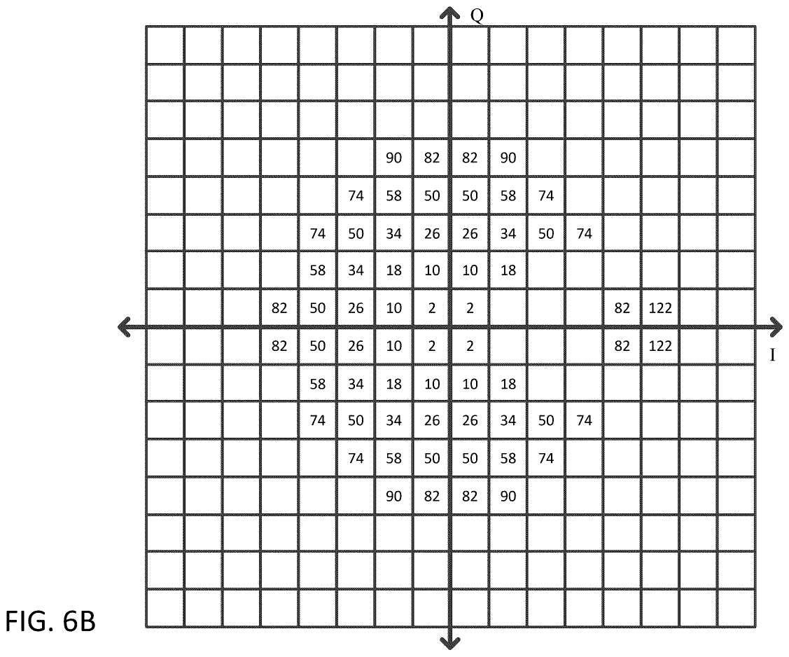

FIG. 4C shows an example of how a mask may be used to reduce power when data throughput requirements can be satisfied using fewer bits per symbol. Instead of expanding the symbol density of 16-QAM symbols, the symbol density and power values of the 16 symbols corresponding to the shaded blocks in FIG. 4A are maintained. The remaining 240 symbols of 256-QAM, shown as blank boxes with the power values from FIG. 4A removed, are “masked” and not used. The 16 unmasked/used symbols may be mapped to new bit sequences (e.g., the 4-bit sequences of 16-QAM symbols in this example). A mask, as described herein, may mask symbol positions of a N-QAM base modulation constellation and with a lower order mask. Although the mask in the example of FIG. 4C results in use symbols that have the same quantity, and are in an arrangement similar to, a conventional lower-order QAM constellation, this need not be the case. A mask may result in a quantity of symbols, and/or an arrangement of symbols, different from conventional QAM constellations. (e.g., a mask may be circular or of arbitrary shape as described herein in FIGS. 6A and 6B).

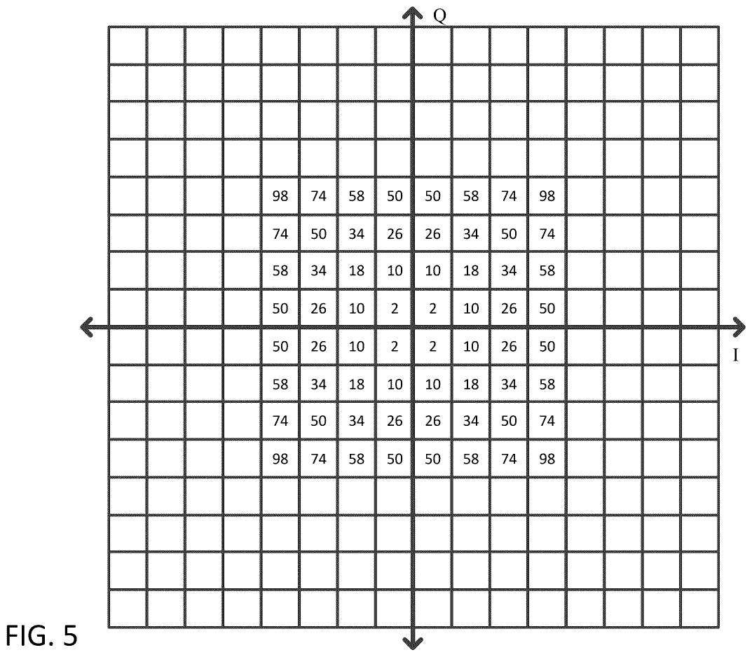

As shown in the example of FIG. 4C, application of a mask may result in an unmasked region QAM symbol constellation of order less than a base QAM constellation, but having a symbol constellation density of the higher order base QAM. FIG. 5 shows an example of applying a mask to 256-QAM base modulation to result in 64 unmasked symbols. Specifically, FIG. 5 shows 256-QAM base of FIG. 4A after application of a 64-QAM mask (shaded) having 6 bits per symbol. The utilization (e.g., throughput) of the 256-QAM base with the 64-QAM mask is 75% of the 256-QAM base, because the 64-QAM mask provides 6 bits per symbol of the potential 8 bits per symbol of the 256-QAM and the ratio of 6 to 8 is 75%. The average power per symbol of the 256-QAM base may be determined to be 170 by summing the power of each symbol in the 256-QAM and dividing by the number of symbols, 256, while the average power per symbol in the masked region may be determined to be 42 by summing the power of each symbol within the 64-QAM and dividing by the number of symbols, 64. From the average power per symbol, the energy-per-bit may be calculated by dividing the average power per symbol by the number of bits. For FIG. 5, for example, the energy-per-bit of the masked region, may be calculated to be 7, while the energy-per-bit of the base modulation may be calculated to be 21.25. A ratio of the energy-per-bit of the after-mask region to the energy-per-bit of the base region may be calculated to evaluate the energy savings of the mask. For FIG. 5, for example, the energy-per-bit of the masked region may be calculated to be 32.94% of the base region. This data and resulting calculations are displayed in Table 1 below.

TABLE 1

| | | | | | Peak to | |
|---|---|---|---|---|---|---|
| | | | Peak | Average | Average | Energy- |
| | Order | Bits | Power | Power | Ratio | per-bit |
| Mask | 64 | 6 | 98 | 42 | 2.33 | 7 |
| Base | 256 | 8 | 450 | 170 | 2.65 | 21.25 |
| Percent | 25 | 75 | 21.78 | 24.71 | | 32.94 |

A mask may be considered a remapping of symbols of a N-QAM base to a M-QAM constellation diagram, where M<N. The mask may comprise and/or be represented (and/or communicated) as a table that identifies symbols (e.g., based on I and Q values) and bit sequences mapped to those symbols. A device may determine the remapping of symbols as a mask, and provide a sending device and a receiving device the mask. A sending device may then send a communication modulated to include symbols identified by the mask. The receiving device may receive the communication and may demodulate that communication based on the mask (e.g., by determining symbols and corresponding bit sequences based on the I and Q values indicated by the mask).

A mask may be predefined and identifiable with a mask identification (e.g., mask ID). A computing device that communicates using a mask (e.g., a CMTS and/or a CMTS member device such as a cable modem, gateway, or STB) may have predefined masks that may be used upon receiving an identification for that mask. The mask may be determined, for example, by a mask ID included in a grant for upstream data transfer or a next codeword pointer (NCP) for downstream data transfer.

As described herein, masks may be associated with different arrangements (e.g., shapes) of unmasked constellation points and corresponding symbols. FIG. 6A shows an example of applying a mask to a 256-QAM base modulation. Specifically, FIG. 6A shows an example of applying a mask to the 256-QAM base modulation of FIG. 4A, and that results in an approximately circular arrangement of 128 remaining/unmasked QAM constellation points. Each of the 128 remaining/unmasked QAM constellation points corresponds to a symbol and may be mapped to a unique 7-bit sequence. A circular shape may be the most energy efficient. This energy efficiency may be due to the circular mask being able to use more lower power symbols by removing more higher power symbols than other shapes. The data for FIG. 6A are shown in Table 2 herein. Notably the utilization (e.g., throughput) may be 87.50% while the energy-per-bit is 54.96%.

TABLE 2

| | | | | | Peak to | |
|---|---|---|---|---|---|---|
| | | | Peak | Average | Average | Energy- |
| | Order | Bits | Power | Power | Ratio | per-bit |
| Mask | 128 | 7 | 170 | 81.75 | 2.08 | 11.68 |
| Base | 256 | 8 | 450 | 170 | 2.65 | 21.25 |
| Percent | 50 | 87.50 | 37.78 | 48.09 | | 54.96 |

Masks may also or alternatively be associated with other arrangements/shapes of unmasked constellation points and corresponding symbols. FIG. 6B shows an example of applying a mask to the 256-QAM base modulation of FIG. 4A, and that results in an irregular shape arrangement of 64 remaining/unmasked QAM constellation points. Each of the remaining/unmasked QAM constellation points corresponds to a symbol and may be mapped to a unique 6-bit sequence. Control of mask shapes may be able to provide additional control of data transmission, bit error, and/or other signal control factors.

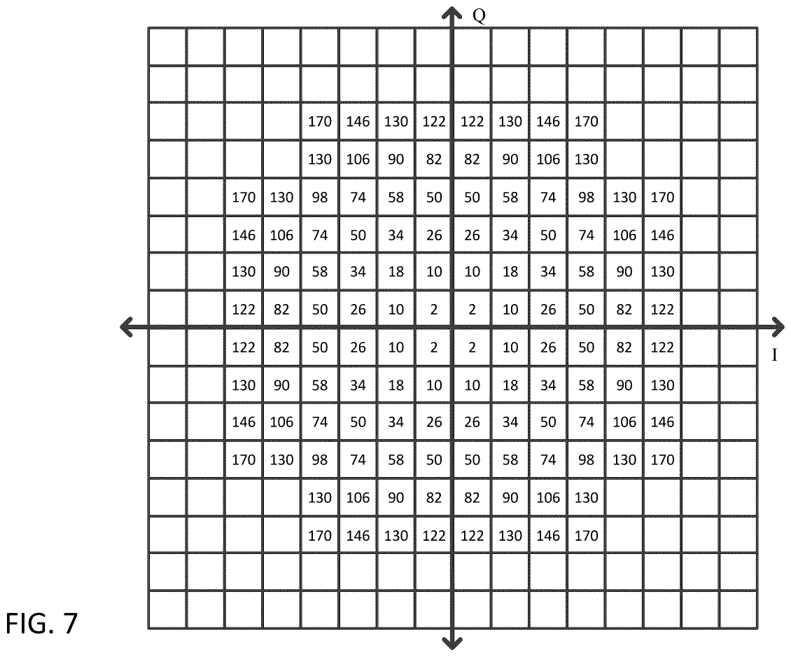

FIG. 7 shows an example of applying a mask to a 256-QAM base modulation.

FIG. 7 shows an example of applying a mask to a 256-QAM base modulation. Specifically, FIG. 7 shows a base modulation of 256-QAM with a 128-QAM cross mask. The cross shape may be a square shape without the corners and thus may perform better than the square because additional higher power bits may be excluded. Like other 128-QAM masks of a 256-QAM base, the utilization (e.g., throughput) with the mask is 87.50% (e.g., 7 bits/8 bits) of the base. The energy-per-bit used with the mask may be 55.13% of energy used of the base. The data for FIG. 6 are shown in Table 3 herein.

TABLE 3

| | | | | | Peak to | |
|---|---|---|---|---|---|---|
| | | | Peak | Average | Average | Energy- |
| | Order | Bits | Power | Power | Ratio | per-bit |
| Mask | 128 | 7 | 170 | 82 | 2.07 | 11.71 |
| Base | 256 | 8 | 450 | 170 | 2.65 | 21.25 |
| Percent | 50 | 87.50 | 37.78 | 48.24 | | 55.13 |

An EPMA may not be limited to any of the above mask shapes and/or any other shape. However, some shapes may not perform as well as basic shapes like a circle or a cross because higher power symbols may still be used for data transmission. Moreover, although many of the examples of QAM bases described herein were 256-QAM, the methods described herein need not be limited to 256-QAM and may be used for any base QAM.

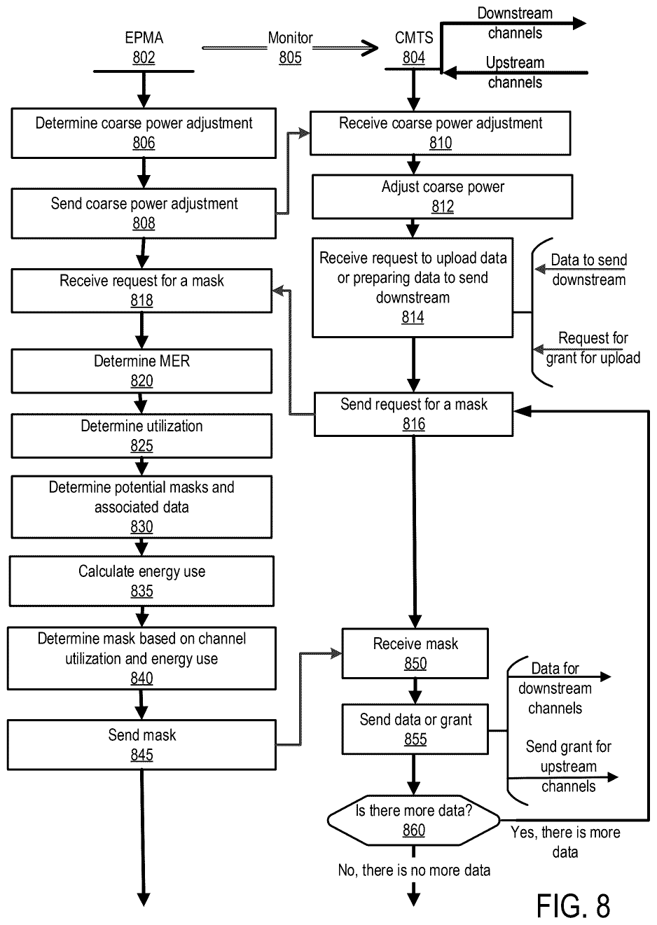

FIG. 8 is a flow chart showing an example method for determining a mask based on analyzing utilization (e.g., throughput) and energy used by a CMTS service group using one or more portions of a communication medium bandwidth. A computing device such as an EPMA server 122 may perform one or more steps of the methods described herein. A computing device in external network 108 may also, or alternatively, perform one or more steps of the method described herein. Also, or alternatively, an I/F 104, a modem 110, a gateway 111, an interface 120, and/or an associated computing device, may perform one or more steps of the methods described herein. A computing device executing an EPMA may communicate with the I/F 104 via one or more networks. The method of FIG. 8 may also or alternatively be performed in connection with communications (e.g., QAM communications) sent and/or received by other types computing devices (e.g., computing devices other than a CMTS, cable modem, or other DOCSIS-based devices).

The method described in FIG. 8 is only an example and one or more of the described steps may be performed in a different order or omitted entirely. Moreover, additional steps may be included to augment the method described in FIG. 8. FIG. 8 shows communications and actions performed by a computing device executing an EPMA 802 and a CMTS 804 to determine and use a mask. As described herein, a computing device executing the EPMA may be referred to as the EPMA. The EPMA 802 and the CMTS 804 may be different computing device or may be integrated into a single computing device that performs the steps outlined herein for both the CMTS 804 and EPMA 802. The CMTS 804 may receive requests from upstream member devices to upload data and may prepare data to send to downstream member devices.

In step 805, the EPMA 802 may continually monitor a service group of a CMTS 804, where that CMTS service group may comprise a set of downstream and/or upstream member devices each in communication with the CMTS 804 via one or more portions of a communication medium bandwidth (e.g., RF bandwidth of an HFC access network). The EPMA 802 may monitor, for example, utilization (e.g., throughput), modulation error ratio (MER), receive and transmit power, errors, performance, quality of service (QoS), configuration, device count, device addresses, signal to noise ratio (SNR), automatic gain control (AGC) settings, noise power ratio (NPR), and/or other network diagnostic measurements.

A bandwidth utilization may be determined as part of step 805. Bandwidth utilization may be determined as a quantity of bits required to provide a determined data throughput. The bandwidth utilization (e.g., utilization) may be an aggregate of one or more one or more portions of a communication medium bandwidth. Bandwidth utilization in an upload and a download direction may be monitored to determine both an upload utilization and a download utilization. The volume of data may be aggregated for a subset of the one or more portions of a communication medium bandwidth of a CMTS 804 service group and/or may be aggregated for all of the one or more portions of a communication medium bandwidth associated with the CMTS 804 service group.

In step 806, the EPMA 802 may determine a coarse power adjustment. A coarse power adjustment may be determined by evaluating a service group's performance (e.g., using MER) for all modems in a CMTS 804 service group. Referring to FIG. 3A, for example, while the MER of one or more portions of a communication medium bandwidth in region A 305a and region C 305c indicate that the MER is sufficiently high to allow the use of symbols having up to 10 bits (e.g., 1024-QAM) in those regions, the MER in region B 305b indicates that the MER is sufficiently high to allow the use of symbols only having up to 4 bits (e.g., 16-QAM). Using a higher order QAM in region B 305b of FIG. 3A, for example, may result in greater errors, a decrease in performance, and/or user dissatisfaction. The base (e.g., nominal) receive power of the entire service group of the CMTS 804 may be determined based on the least performing device(s) of the service group.

In step 808, the EPMA 802 may send the coarse power adjustment to the CMTS 804, and in step 810, the CMTS 804 may receive the coarse power adjustment from the EPMA 802. The base receive power of the entire CMTS 804 service group may be adjusted by the coarse power adjustment, for example, based on the least performing device(s) of the service group.

In step 812, the CMTS 804 may adjust coarse power. A coarse power adjustment may result in a uniform power savings. The coarse power adjustment may be baselined to a least performing device or devices in a population. Power savings may be gained by adjusting the coarse power, for example, every 3 dB is half the power and a reduction of 0.5 dB is almost a 10 percent power savings.

In step 814, the CMTS 804 may receive a request from a downstream member device to upload data or the CMTS 804 may receive data to prepare to send (e.g., download) to a downstream member device. The request for an upload may include an amount of data to upload, a type of data, and/or preferred rates of data transfer. Similarly, data being prepared to send may be analyzed to determine an amount of data to send, a type of data, and/or preferred rates of data transfer. Streaming video, for example, may benefit from greater data transfer rates, while data downloaded in the background while other applications are being used may use lower data transfer rates without impacting a user's experience.

In step 816, the CMTS 804 may send a request to the EPMA 802 for a mask. The mask may be for one or more portions of a communication medium bandwidth of an upstream or a downstream data transfer. For an upstream data transfer, for example, the mask may be for an upstream member device to upload data. The upstream member device may request a grant to upload data to the CMTS 804, and the CMTS 804 may send, in response to the grant request, a request to the EPMA 802 to designate a mask to modulate the upload data. For a downstream data transfer, for example, the mask may be for the CMTS to send (e.g., transmit) data to a downstream member device. The request may comprise a list of a subset of the one or more portions of a communication medium bandwidth that the data may be sent (e.g., transmitted) on. In step 818, EPMA 802 may receive the request, from the CMTS, for the mask.

In step 820, EPMA 802 may receive and/or determine MER for the one or more portions of a communication medium bandwidth that may be used to download or upload data to or from a member device of the CMTS 804 service group. The EPMA 802 may continually collect per-member device MER metrics and adjust associated profiles of the member devices accordingly. The modulations for the one or more portions of a communication medium bandwidth within these profiles may be the baseline for the constellation masks that may be applied.

In step 825, the EPMA 802 may calculate utilization (e.g., throughput) values for the one or more portions of a communication medium bandwidth. The EPMA 802, for example, may continually monitor utilization (e.g., throughput) of the one or more portions of a communication medium bandwidth of the CMTS 804 as described in step 805. In monitoring utilization (e.g., throughput), a system's performance may be evaluated for member devices in a service group, and the performance may be evaluated by determining a modulation error ratio (MER). Data utilization (e.g., throughput) may be based on current data volumes and/or current data rates of a particular set of the one or more portions of a communication medium bandwidth associated with a member device. Alternatively, data utilization (e.g., throughput) may include adjustments based on known increases and/or decreases in usage based on time of day, day of the week, holidays, current events, etc. By determining a number of bits required to be transmitted and/or a time period for the transmission, a utilization (e.g., throughput) value may be calculated.

Utilization (e.g., throughput), generally, may be considered the amount of available communication bits that are needed. In 256-QAM, for example, 8 bits (e.g., 2⁸=256) are transmitted in a symbol period, and if only 6 bits of data is needed to be transmitted per symbol period the utilization (e.g., throughput) would be 6/8=0.75=75%. More power may be used to transmit the 6 bits than may be necessary.

Additionally, the EPMA may determine more than one utilization (e.g., throughput) value. With the EPMA, for example, utilization (e.g., throughput) may be determined as a utilization (e.g., throughput) value with the effect of the EPMA mask in effect (e.g., actual utilization) which accounts for the effect with the EPMA mask enabled. A second utilization may be a utilization (e.g., throughput) value with the effect of the EPMA removed (e.g., adjusted utilization), for example, which would be the utilization metrics reported by DOCSIS. For a 256-QAM base with a 64-QAM mask using only 4 bits of the available utilization (e.g., throughput), for example, the actual utilization (e.g., throughput) would be the 4 data bits used divided by the 6 available bits in the 64-QAM mask (e.g., 2⁶=64) and the adjusted utilization (e.g., throughput) would be the 4 data bits used divided by the 8 available bits in the 256-QAM base, resulting in a 75% actual utilization (e.g., throughput) and a 50% adjusted utilization (e.g., throughput).

Additionally, even for 100% utilization (e.g., throughput), constellation masks may be applied to the case of shortened codewords and achieve some energy savings. Shortened codewords may be used for several purposes. Shortened codewords may be used, for example, if there is insufficient data to fill complete codewords.

Every mask may have an average bit load. An average bit load, for a subset of one or more portions of a communication medium bandwidth, may be determined, for example, by summing the bit loads of each member of the subset of the one or more portions of a communication medium bandwidth and dividing by a number of members of the subset. Masks may be specified as the number of bits of reduction. The average bit load, in most cases, may be reduced by the number of bits of reduction (e.g., n), for example, if masks are specified as the number of bits of reduction. Moreover, the utilization (e.g., throughput) of a masked profile may be calculated to be the difference of the average bit load and the number of bits of reduction divided by the average bit load (e.g., (average bit load-n)/average bit load).

In step 830, the EPMA 802 may determine one or more potential masks and associated information of the mask (e.g., mask shape, mask modulation, etc.). A potential mask may be determined, for example, based on the utilization (e.g., throughput) determined in step 825. The determined masks may comprise QAM masks, circular masks, square masks, irregular masks, etc. that provide the necessary utilization (e.g., throughput). Masks may be determined by the EPMA 802, for a case of a subset of the one or more portions of a communication medium bandwidth using 256-QAM in step 825, for example, that requires only 4 bits per symbol to be sent (e.g., transmitted) over the next symbol transfer period. The EPMA 802 may determine a number of masks that may be capable of providing the necessary utilization (e.g., throughput) of 4 bits per symbol, for example, including 64-QAM, 16-QAM, a circular mask as described herein in FIG. 6A, an irregular mask as described herein in FIG. 6B, etc.

In step 835, the EPMA 802 may calculate one or more energy use values. Energy use values may comprise total power used, energy-per-bit, etc. and may provide data that the EPMA 802 may use to provide energy savings associated with the data transfer. Total power used, for example, may be determined by summing the peak power used by the symbols within the mask. Different masks (e.g., different mask shapes) may provide different levels of energy savings. A circular mask with any number of symbols, for example, may be generated. Additionally, as described herein in FIG. 6B, other mask shapes may be determined based on additional needs of the CMTS 804.

In step 840, the EPMA 802 may determine the mask to use for the upstream grant from a downstream member device of the CMTS 804 or the downstream preparation of data by the CMTS for a downstream member device. The EPMA 802 may determine, for example, that the mask providing the greatest amount of power savings (e.g., the lowest total power used or lowest energy-per-bit) to be the mask. Other considerations may be used in determining the appropriate mask. Other considerations in determining a mask may include time constraints on calculating masks, the type of data to be sent (e.g., transmitted), other issues with the CMTS 804 or the CMs of the CMTS 804 service groups, variability in utilization (e.g., throughput), data transfer rates, the number of CM within the CMTS 804 service group, and/or any other issues that may affect user transfer rates, energy usage, and/or user satisfaction.

In step 845, the EPMA 802 may send (e.g., transmit) the mask to the CMTS 804, and in step 850, the CMTS 804 may receive the mask. The EPMA 802 may also or alternatively send a mask ID. Mask IDs, and their associated masks, may be predefined and stored locally at the CMTS 804 and/or service group devices, so that the EPMA 802 may inform the CMTS 804 to use a mask as well as the mask to use by sending (e.g., transmitting) the mask ID to the CMTS 804.

In step 855, for the case of a CMTS 804 preparing data to send (e.g., transmit) to a downstream member device, the CMTS may send (e.g., transmit) a next codeword pointer (NCP) comprising the mask as a new field in the NCP. The downstream member device may use the NCP to determine the mask to use to demodulate the data generated and transmitted using symbols based on the mask upon receipt. The data may be prepared to send (e.g., transmit).

The CMTS 804 may prepare data to send (e.g., transmit) using the mask. The data may be prepared by generating and sending symbols based on the mask. Using the mask on the data may comprise remapping symbols to unmasked regions of the N-QAM base as described by the mask. The data may be modulated per the mask. The data may be modulated for a base modulation associated with communication via one or more portions of a communication medium bandwidth

The CMTS 804 may send (e.g., transmit) the data, using the mask, to one or more downstream member devices. The data may be received by the downstream member device and the data may demodulated using the determined mask identified in the NCP.

Alternatively in step 855, for the case of a CMTS 804 responding to a grant request for a downstream member device to upload data, the CMTS 804 may send (e.g., transmit) the mask to the downstream member device as part of an upload grant, where the mask is a new field in the grant, in response to the downstream member device's request for the upload grant. The downstream member device may then use the mask to generate and transmit the data.

In step 860, it may be determined if additional data is to be generated and transmitted. It may be determined, for example, if an additional grant for the upload of additional data by a downstream member device of the CMTS 804 is required, or it may be determined, for example, if additional data is to be generated and transmitted for download to a downstream member device of the CMTS 804. Additional requests for masks may be sent (e.g., transmitted), in step 816, to the EPMA 802, for example, if additional data is to be generated and transmitted. Conversely, the mask request may end, for example, if there is no additional data to be generated and transmitted.

In addition to the method as outlined in FIG. 8, the EPMA 802 may automatically determine new mask characteristics during routine review of the MER of the CMTS 804 service group. The EPMA 802 may determine, for example, that a baseline mask for subsets of the one or more portions of a communication medium bandwidth of the CMTS 804 service group may be adjusted based on the associated MER.

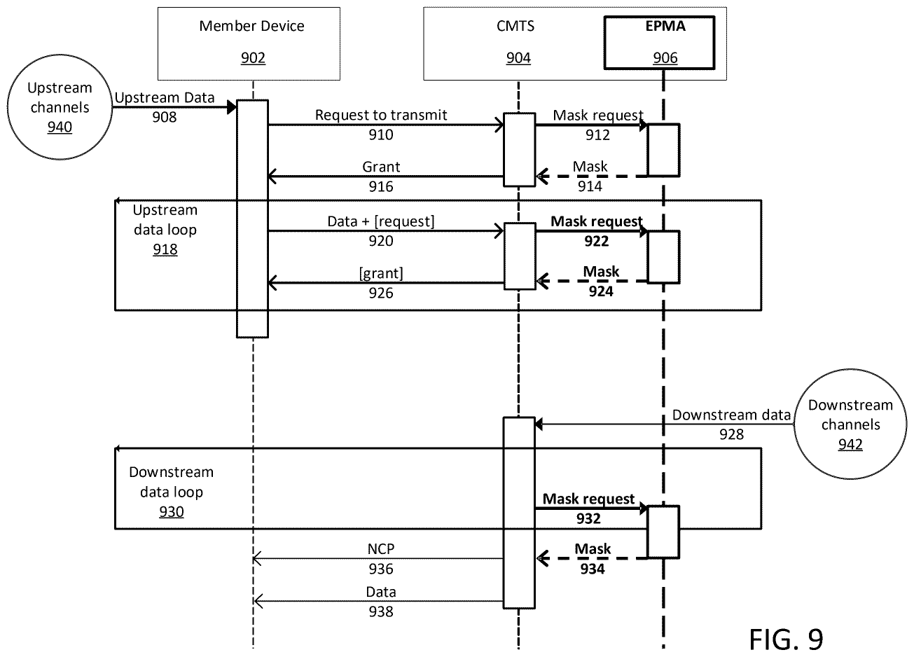

FIG. 9 shows a sequence diagram depicting a simplified flow of upstream and downstream data between a member device 902 (e.g., a cable modem and/or other type of user device) and a cable modem termination system (CMTS) 804. The data flows shown in FIG. 9 may occur in connection with performing the method of FIG. 8. The CMTS 804 and an EPMA 802 may be coupled or co-located. For upstream data 908, the member device 902 may issue an initial request 910 to the CMTS 804 to send (e.g. transmit) data. The CMTS 804 may request a mask 912 from the EPMA 802. The EPMA 802 may respond with an appropriate mask 914. The CMTS 804 may respond to the member device 902 with a grant 916. The mask may be a new field in the grant 916. This method may be looped 918, for example, while there is more data to send (e.g. transmit). The member device 902 may send (e.g., transmit) data plus a request 920 to the CMTS 804, for example, where the request may be optional and may be present if there is more data. The CMTS 804 may ask for a mask 922 from the EPMA 802. The EPMA 802 may respond with an appropriate mask 924. If a request was present in the data plus a request 920, the CMTS 804 may respond with a grant 926 and the mask 924, where the mask may be a new field in the grant 926.

This process may vary. A CMTS 804 may not request a new mask for all upstream data transfer. The CMTS 804 may not request a new mask, for example, based on the data type, based on some parameter defining how often a CMTS 904 may request a mask, and/or based on current data transfer schemes between a member device 902 and the CMTS 804. The CMTS 804 and member device 902 may reuse a prior mask, for example, if the CMTS 804 does not request a mask. The member device 902 may continue to use the prior mask until provided with a new mask and/or instructed to not use the prior mask.

The method for downstream data 928, may be looped 930 if there is data to send (e.g. transmit). The CMTS 804 may request a mask 932 from the EPMA 802. The EPMA 802 may respond with an appropriate mask 934. The CMTS may send (e.g. transmit) a NCP 936, where the mask may be a new field in the NCP. The CMTS 804 may generate and send (e.g. transmit) the data 938, using symbols based on the mask, to the member device 902.

The EPMA 802 may continuously monitor utilization (e.g., throughput) of one or more portions of a communication medium bandwidth upstream carrier 940 and one or more portions of a communication medium bandwidth downstream carrier 942. Both an actual utilization (e.g., throughput) value, that may account for the effect of the EPMA mask, and an adjusted utilization (e.g., throughput) value may, that may remove the effect of the EPMA mask, may be monitored and/or determined. Existing DOCSIS utilization (e.g., throughput) metrics may report the adjusted utilization (e.g., throughput). In determining the appropriate mask, the EPMA 802 may consider the adjusted utilization (e.g., throughput) and choose the mask that provides the most energy savings while maintaining a minimum utilization (e.g., throughput). The base modulation may be 256-QAM and the adjusted utilization (e.g., throughput) may be 70%, for example, and the EPMA 802 may choose a 64-QAM mask to maintain the adjusted utilization. The 64-QAM mask may provide 75% utilization (e.g., throughput), 6/8 of the bits, of the 256-QAM base.

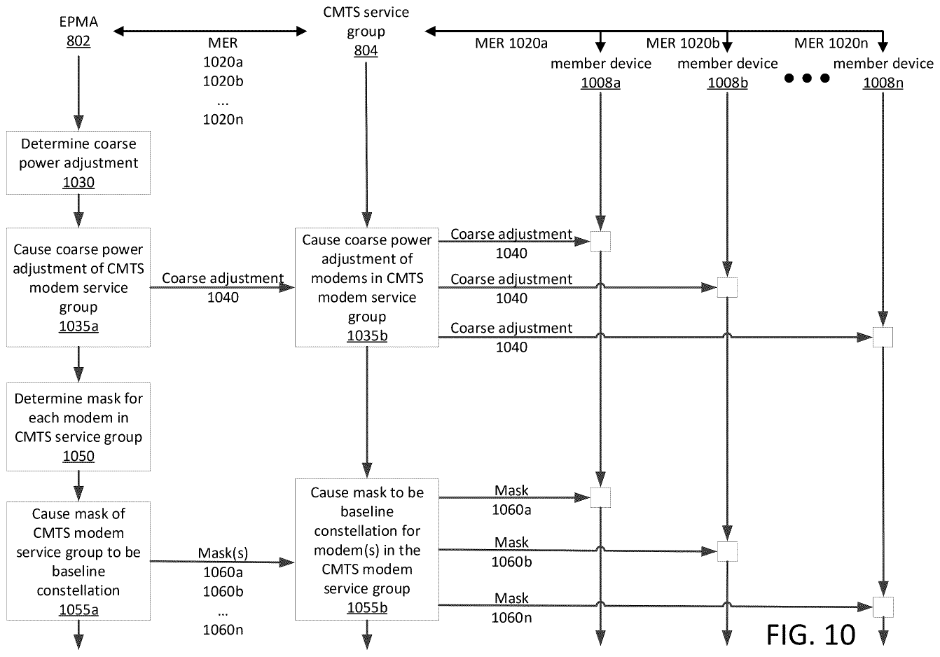

FIG. 10 shows a sequence diagram for a system comprising an EPMS, a CMTS, and member devices of the CMTS. The data flows shown in FIG. 10 may occur in connection with performing the method of FIG. 8. A CMTS service group may be able to serve thousands to tens of thousands of cable modems, but generally serve several hundred to thousands of cable modems to increase the performance of the CMTS service group as well as user satisfaction. A CMTS 804 service group, for example, may serve member devices 1008a through 1008n (e.g., cable modems). The CMTS 804 service group may be collecting MER data 1020a through 1020n periodically or continuously. MER data 1020a through 1020b may be determined during uploads and/or downloads of data.

In step 1030, the EPMA 802 may determine a coarse power adjustment for the CMTS 804 service group. The MER data 1020a through 1020n may be viewed as a spectral diagram, as described herein in FIG. 3A. Referring to FIG. 3A, for example, while the subset of one or more portions of a communication medium bandwidth of region A 305a and region C 305c have MER values indicating that 1024-QAM may be usable, the subset of one or more portions of a communication medium bandwidth of region B 305b of FIG. 3A have lower MER values that may result in increased errors and/or reduced transmission speeds if QAM constellations greater than 16-QAM is used.

In step 1035a, a coarse power adjustment, based upon the modulation error rate (MER) 1020a through 1020n for the modems in the CMTS 804 service group, may be sent (e.g., transmitted) to the CMTS of the CMTS 804 service group. The entire service group may be adjusted by the commanded nominal receive power one or more portions of a communication medium bandwidth. This may result in uniform power savings, baselined to the least performing device(s) in the service group.

In step 1035b, the CMTS of the CMTS 804 service group may apply the coarse power adjustment 1040 to each of the member devices 1008a through 1008n of the CMTS 804 service group. By adjusting the nominal receive power of all the member devices 1008a through 1008n in the CMTS 804 service group, for example, energy savings nearing 10 percent may be achieved by reducing the MER by 0.5 dB.

In step 1050, based on a utilization (e.g., throughput) value and an energy-per-bit and/or total power used, a mask may be determined for each member device 1008a through 1008n of the CMTS 804 service group based on each member device's individual MER. The EMPA 802 may continually collect the MER 1020a through 1020n for each member device 1008a through 1008n in the CMTS 804 service group. The MER of each modem 1020a through 1020n may be used to determine an adjustment to a mask (e.g., mask(s) 1060a through 1060n) that may be used as a baseline constellation for each associated member device 1008a through 1008n.

In step 1055a, the EPMA 802 may send (e.g. transmit), to the CMTS 804, the masks 1060a through 1060n to be used for modulation and/or demodulation of one or more of the member devices 1008a through 1008n of the CMTS 804 service group. The details of how the EPMA may send (e.g. transmit) the mask are described herein in FIG. 8. In step 1055b, the CMTS 804 of the CMTS 804 service group may receive the one or more masks 1060a through 1060n for one or more of the member devices 1008a through 1008n of the CMTS 804 service group, and the CMTS 804 may cause one or more of modems 1008a through 1008n to adjust their profiles by applying one or more of the masks 1060a through 1060n to the appropriate modem of modems 1008a through 1008n.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

What is claimed is:

1. A method, comprising:
receiving, by a computing device and for a base modulation associated with communication via one or more portions of a communication medium bandwidth, a request for a modulation symbol mask, wherein the base modulation comprises a plurality of base modulation symbols respectively corresponding to a plurality of base modulation symbol bit sequences;
determining, for the base modulation, a utilization that indicates a portion, of an available capacity of the communication medium bandwidth, required to provide a determined data throughput;
determining, based on the utilization, a modulation symbol mask that comprises:
a plurality of mask symbols that comprises a subset of the plurality of base modulation symbols; and
a plurality of mask symbol bit sequences that respectively correspond to the plurality of mask symbols; and
sending, to a second computing device, an indication of the determined modulation symbol mask.

2. The method of claim 1, wherein the determining the modulation symbol mask comprises:
Determining, based on the utilization, a plurality of potential modulation symbol masks that satisfy the utilization; and
Selecting, based on the total potential energy use values associated with the plurality of potential modulation symbol masks, the modulation symbol mask from the plurality of potential modulation symbol masks.

3. The method of claim 2, further comprising:
determining, for each of the plurality of modulation symbol masks, a total potential energy use value based on potential energy used for each of a plurality of mask symbols that comprise a subset of the plurality of base modulation symbols, wherein the selecting comprises selecting, as the determined modulation symbol mask, a modulation symbol mask, of the plurality of potential modulation symbol masks, associated with a lowest determined total potential energy use value.

4. The method of claim 1, wherein determining the utilization comprises determining a quantity of bits, of the plurality of base modulation symbol bit sequences, required to provide a determined data throughput via the one or more portions of a communication bandwidth.

5. The method of claim 1, wherein the plurality of mask symbols excludes base modulation symbols, of the plurality of base modulation symbols, at outer corners of a base modulation symbol constellation and comprises one of:
base modulation symbols, of the plurality of base modulation symbols, forming a circle shape positioned over a center of the base modulation symbol constellation,
base modulation symbols, of the plurality of base modulation symbols, forming a rectangular shape positioned over a center of the base modulation symbol constellation,
base modulation symbols, of the plurality of base modulation symbols, forming a square shape positioned over a center of the base modulation symbol constellation,
base modulation symbols, of the plurality of base modulation symbols, forming a cross shape positioned over a center of the base modulation symbol constellation, or
base modulation symbols, of the plurality of base modulation symbols, forming one or more irregular shapes.

6. The method of claim 1, wherein the sending the indication of the determined modulation symbol mask comprises sending one or more of:
an identifier of the determined modulation symbol mask, or
data indicating the plurality of mask symbols and data indicating the plurality of mask symbol bit sequences.

7. The method of claim 1, wherein the base modulation comprises quadrature amplitude modulation (QAM).

8. The method of claim 1, wherein the determined modulation symbol mask:
excludes base modulation symbols, of the plurality of base modulation symbols, at outer corners of a base modulation symbol constellation, and
maintains symbol power values of the remaining base modulation symbols.

9. A method, comprising:
receiving, by a computing device and for a base modulation associated with communication via one or more portions of a communication medium bandwidth, a request for a modulation symbol mask, wherein the base modulation comprises a plurality of base modulation symbols respectively corresponding to a plurality of base modulation symbol bit sequences;
determining, for the base modulation, a utilization that indicates a quantity of bits, of the plurality of base modulation symbol bit sequences, required to provide a determined data throughput via the one or more portions of a communication bandwidth;
determining a plurality of potential modulation symbol masks that satisfy the utilization;
selecting, based on total potential energy use values associated with the plurality of potential modulation symbol masks, a modulation symbol mask of the plurality of potential modulation symbol masks; and
sending, to a second computing device, an indication of the selected modulation symbol mask.

10. The method of claim 9, wherein each of the plurality of potential modulation symbol masks comprises:
a plurality of mask symbols that comprises a subset of the plurality of base modulation symbols; and
a plurality of mask symbol bit sequences that respectively correspond to the plurality of mask symbols.

11. The method of claim 9, further comprising:
determining, for each of the plurality of potential modulation symbol masks, a total potential energy use value based on potential energy used for each of a plurality of mask symbols of the potential modulation symbol mask, wherein the selecting comprises selecting a modulation symbol mask, of the plurality potential modulation symbol masks, associated with a lowest total potential energy use value.

12. The method of claim 9, wherein the selected modulation symbol mask excludes base modulation symbols, of the plurality of base modulation symbols, at outer corners of a base modulation symbol constellation and comprises one of:
base modulation symbols, of the plurality of base modulation symbols, forming a circle shape positioned over a center of the base modulation symbol constellation,
base modulation symbols, of the plurality of base modulation symbols, forming a rectangular shape positioned over a center of the base modulation symbol constellation,
base modulation symbols, of the plurality of base modulation symbols, forming a square shape positioned over a center of the base modulation symbol constellation,
base modulation symbols, of the plurality of base modulation symbols, forming a cross shape positioned over a center of the base modulation symbol constellation, or
base modulation symbols, of the plurality of base modulation symbols, forming one or more irregular shapes.

13. The method of claim 9, wherein the sending the indication of the selected modulation symbol mask comprises sending one or more of:
an identifier of the selected modulation symbol mask, or
data indicating a plurality of mask symbols and data indicating a plurality of mask symbol bit sequences.

14. The method of claim 9, wherein the base modulation comprises quadrature amplitude modulation (QAM).

15. A method, comprising:
receiving, by a computing device and for a base modulation associated with communication via one or more portions of a communication medium bandwidth, a request for a modulation symbol mask;
determining, for the base modulation, a utilization that indicates a portion, of an available capacity of the communication medium bandwidth, required to provide a determined data throughput;
determining, based on the utilization, a modulation symbol mask that:
excludes base modulation symbols, of a plurality of base modulation symbols, at outer corners of a base modulation symbol constellation, and
maintains symbol power values of remaining base modulation symbols; and
sending, to a second computing device, an indication of the determined modulation symbol mask.

16. The method of claim 15, wherein the base modulation comprises a plurality of base modulation symbols respectively corresponding to a plurality of base modulation symbol bit sequences.

17. The method of claim 15, wherein determining the utilization comprises determining a quantity of bits, of a plurality of base modulation symbol bit sequences, required to provide the determined data throughput via the one or more portions of a communication medium bandwidth.

18. The method of claim 15, wherein the modulation symbol mask comprises one of:
base modulation symbols, of the plurality of base modulation symbols, forming a circle shape positioned over a center of the base modulation symbol constellation,
base modulation symbols, of the plurality of base modulation symbols, forming a rectangular shape positioned over a center of the base modulation symbol constellation,
base modulation symbols, of the plurality of base modulation symbols, forming a square shape positioned over a center of the base modulation symbol constellation,
base modulation symbols, of the plurality of base modulation symbols, forming a cross shape positioned over a center of the base modulation symbol constellation, or
base modulation symbols, of the plurality of base modulation symbols, forming one or more irregular shapes.

19. The method of claim 15, wherein the sending the indication of the determined modulation symbol mask comprises sending one or more of:
an identifier of the determined modulation symbol mask, or
data indicating a plurality of mask symbols and data indicating a plurality of mask symbol bit sequences.

20. The method of claim 15, wherein the base modulation comprises quadrature amplitude modulation (QAM).
